(19) United States
(12) Patent Application Publication
(10) Pub. No.: US 2016/0056590 A1
(43) Pub. Date: Feb. 25, 2016

(54) CONNECTOR

(71) Applicant: YAZAKI CORPORATION, Tokyo (JP)

(72) Inventors: Fuminori SUGIYAMA, Shizuoka (JP); Kazushige SHIOTA, Shizuoka (JP); Shigeo MORI, Shizuoka (JP); Masayuki KATAOKA, Shizuoka (JP)

(21) Appl. No.: 14/918,640

(22) Filed: Oct. 21, 2015

Related U.S. Application Data
(63) Continuation of application No. PCT/JP2014/061865, filed on Apr. 28, 2014.

(30) Foreign Application Priority Data
Apr. 30, 2013 (JP) 2013-094951
Sep. 6, 2013 (JP) 2013-185143

(51) Int. Cl. H01R 13/74; H01R 13/58

(52) U.S. Cl. CPC H01R 13/748; H01R 13/5845

(57) ABSTRACT

A connector includes an integrated housing integrated with a shield shell, an end portion of an electric wire, and a terminal fitting in a state where a tip portion of the terminal fitting is exposed to the outside of the integrated housing so as to integrally fix the shield shell, the end portion of the electric wire, and also the terminal fitting.

### CROSS REFERENCE TO RELATED APPLICATIONS

This application is a continuation of International Application No. PCT/JP2014/061865, filed Apr. 28, 2014, and based upon and claims the benefit of priority from Japanese Patent Applications No. 2013-094951, filed Apr. 30, 2013, and No. 2013-185143, filed Sep. 6, 2013, the entire contents of all of which are incorporated herein by reference.

### TECHNICAL FIELD

The present application relates to a connector.

### BACKGROUND ART

A high-voltage connector directly attached to an apparatus such as an inverter used for an electric vehicle is required to have various functions such as a conductive function, an insulating function, a waterproof function, and an electromagnetic shielding function. Such a connector is composed of assembled components having different functions. JP 2003-272729 A (PTL 1) describes a connector having the functions described above.

A conventional connector as described in PTL 1 or JP 2012-151067 A (PTL 2) has a configuration in which an end portion of an electric wire is connected with a terminal fitting, the end portion of the electric wire is housed in a housing, and the housing is inserted into a shield shell so as to have an electricity-transmitting function, an insulating function, and an electromagnetic shielding function. In order to further ensure a waterproof function, a seal ring is placed between the end portion of the electric wire and the housing, an O-ring is placed between the terminal fitting and the housing, and a unit packing is placed between the housing and an apparatus. In addition, in order to ensure a component-holding function to fix the electric wire to the housing and fix the seal ring to the housing, a rear holder is attached to the rear side of the housing.

### SUMMARY

Such a connector required to have various functions such as a conductive function, an insulating function, a waterproof function, an electromagnetic shielding function, and further a component-holding function inevitably includes many components corresponding to the number of functions required. Thus, the process of assembling the connector is complicated, and the number of assembling steps increases. Further, a space is necessary per component having each individual function to assemble the connector, which restricts a reduction in size of the connector.

An object of the present application is to provide a connector in which the number of components is reduced, an assembling process is simplified, and a space for each component is saved even when the connector is required to have various functions.

A connector according to an aspect of the present application includes: an electric wire; a terminal fitting connected to an end portion of the electric wire; and an integrated housing molded on the end portion of the electric wire and the terminal fitting in a state where a tip portion of the terminal fitting is exposed to an outside of the integrated housing so as to integrally fix the end portion of the electric wire and the terminal fitting.

The integrated housing molded on the end portion of the electric wire and the terminal fitting has a function to insulate the respective components, a component-holding function and a waterproof function to protect the electric wire, the terminal fitting and a portion attached to a mating connector against water. Since the integrated housing has the function to insulate the respective components, the component-holding function and the waterproof function, the number of the components required for the connector to ensure the necessary functions can be reduced.

The decrease in the number of the components can simplify the process of assembling the connector to decrease the assembling steps. The decrease in the number of the components can further save the space for the respective components so as to reduce the size of the connector.

The connector according to the aspect of the present application may further include a shield shell into which the terminal fitting and the end portion of the electric wire are inserted. The integrated housing is integrated with the shield shell together with the end portion of the electric wire and the terminal fitting so as to integrally fix the end portion of the electric wire, the terminal fitting and the shield shell.

Since the integrated housing is integrated with the end portion of the electric wire, the terminal fitting, and also the shield shell, the shield shell functions as a reinforcing member of the integrated housing. Accordingly, the integrated housing can be formed of a material having lower rigidity than materials generally used for housings, which expands the possibility of materials to be selected.

The shield shell may include a wire insertion cylindrical body into which the end portion of the electric wire and the terminal fitting connected to the end portion of the electric wire are inserted and a fixing flange portion used for fixing the connector to a mating connector. The wire insertion cylindrical body may include a front end cylindrical portion in which the end portion of the electric wire is housed, and a rear end cylindrical portion of which the electric wire is lead out. The integrated housing may include a front end cylindrical housing portion integrated with the front end cylindrical portion, a rear end cylindrical housing portion integrated with the rear end cylindrical portion, and a wire leading-side housing portion integrated with the electric wire led out of the rear end cylindrical portion.

The integrated housing includes the front end cylindrical housing portion integrated with the front end cylindrical portion of the shield shell, the rear end cylindrical housing portion integrated with the rear end cylindrical portion of the shield shell, and the wire leading-side housing portion integrated with the electric wire led out of the rear end cylindrical portion of the shield shell. The front end cylindrical housing portion functions to protect the connected portion of the terminal fitting and the electric wire against water and hold these components. The rear end cylindrical housing portion functions to protect the electric wire against water and hold the electric wire. Accordingly, the waterproof and component-holding performance can be ensured reliably by the integrated housing.

The integrated housing may be provided with a seal portion that tightly comes into contact with the mating connector.

Since the seal portion brought in tight contact with the mating connector is formed in the integrated housing, the portion attached to the mating connector can be protected against water.

A plurality of seal portions may be formed.

A pressure-reducing effect due to the plural seal portions can improve the waterproof performance.

Each seal portion may be provided with a permanent magnet so as to tightly come into contact with the mating connector due to magnetic force of the permanent magnet.

The adhesion by the magnetic force of the permanent magnet can improve the waterproof performance.

### BRIEF DESCRIPTION OF DRAWINGS

FIG. 1 is a perspective view illustrating a connector according to a first embodiment.

FIG. 2 is a cross-sectional view illustrating the connector according to the first embodiment.

FIG. 3 is a perspective view illustrating a state where an end portion of an electric wire is connected with a terminal fitting according to the first embodiment.

FIG. 4 is a perspective view illustrating a state where the end portion of the electric wire and the terminal fitting are inserted into a shield shell according to the first embodiment.

FIG. 5 is a perspective view illustrating a state where an integrated housing is molded on the components illustrated in FIG. 4.

FIG. 6 is a perspective view illustrating a connector according to a second embodiment.

FIG. 7 is a cross-sectional view illustrating the connector according to the second embodiment.

FIG. 8 is a perspective view illustrating a connector according to a third embodiment.

FIG. 9 is a cross-sectional view illustrating the connector according to the third embodiment.

FIG. 10 is a perspective view illustrating a state where an end portion of an electric wire is connected with a terminal fitting according to the third embodiment.

FIG. 11 is a perspective view illustrating a state where the end portion of the electric wire and the terminal fitting are inserted into a shield shell according to the third embodiment.

FIG. 12 is a perspective view illustrating a state where an integrated housing is molded on the components illustrated in FIG. 11.

FIG. 13 is a perspective view illustrating a connector according to a fourth embodiment.

FIG. 14 is a cross-sectional view illustrating the connector according to the fourth embodiment.

FIG. 15 is a perspective view illustrating a state where an end portion of an electric wire is connected with a terminal fitting according to the fourth embodiment.

FIG. 16 is a perspective view illustrating a state where an integrated housing is molded on the components illustrated in FIG. 15 according to the fourth embodiment.

FIG. 17 is a perspective view illustrating a state where a shield shell is fitted to the components illustrated in FIG. 16.

FIG. 18 is a perspective view illustrating a connector according to a fifth embodiment.

FIG. 19A is a cross-sectional view illustrating the connector according to the fifth embodiment, and FIG. 19B is an enlarged view illustrating region A of FIG. 19A.

FIG. 20 is a perspective view illustrating a state where an end portion of an electric wire is connected with a terminal fitting according to the fifth embodiment.

FIG. 21 is a perspective view illustrating a state where the end portion of the electric wire and the terminal fitting are inserted into a shield shell, and a ring-shaped permanent magnet is fitted to an outer circumference of the shield shell according to the fifth embodiment.

FIG. 22 is a perspective view illustrating a state where an integrated housing is integrally molded with the end portion of the electric wire, the terminal fitting, the ring-shaped permanent magnet, and the shield shell used as insert components according to the fifth embodiment.

FIG. 23 is a cross-sectional view illustrating a connector according to a sixth embodiment.

FIG. 24 is a cross-sectional view illustrating a connector according to a seventh embodiment.

FIG. 25 is a cross-sectional view illustrating a connector according to an eighth embodiment.

FIG. 26A is a perspective view illustrating a terminal fitting according to a ninth embodiment, and FIG. 26B is a perspective view illustrating a terminal fitting according to a modified example of the ninth embodiment.

### DESCRIPTION OF EMBODIMENTS

Hereinafter, embodiments of the present application will be explained with reference to the drawings. Note that the same elements in the respective embodiments are indicated by the same reference numerals so as to correspond to each other.

### First Embodiment

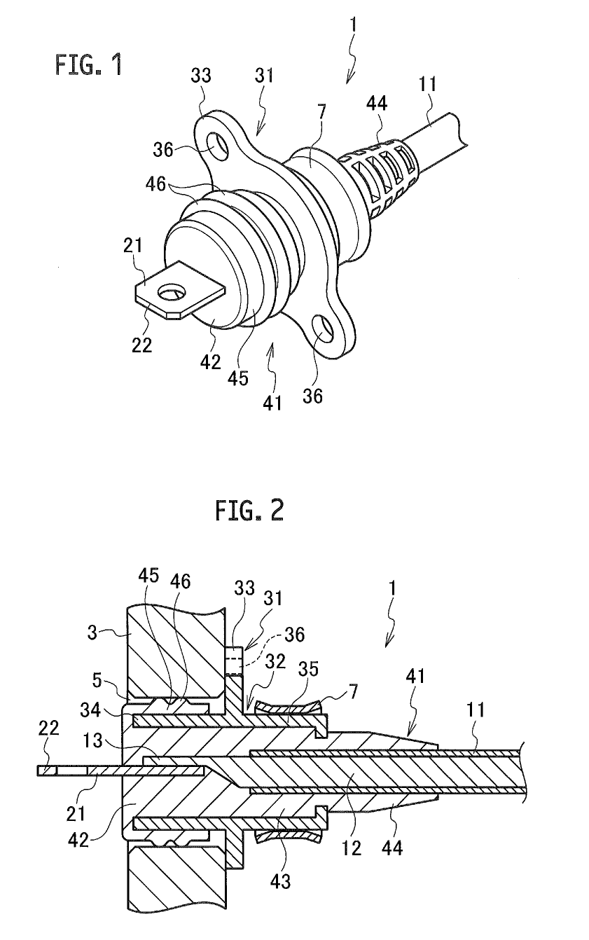

FIGS. 1 to 5 illustrate a connector 1 according to a first embodiment.

The connector 1 includes an electric wire 11, a terminal fitting 21, a shield shell 21, and an integrated housing 41.

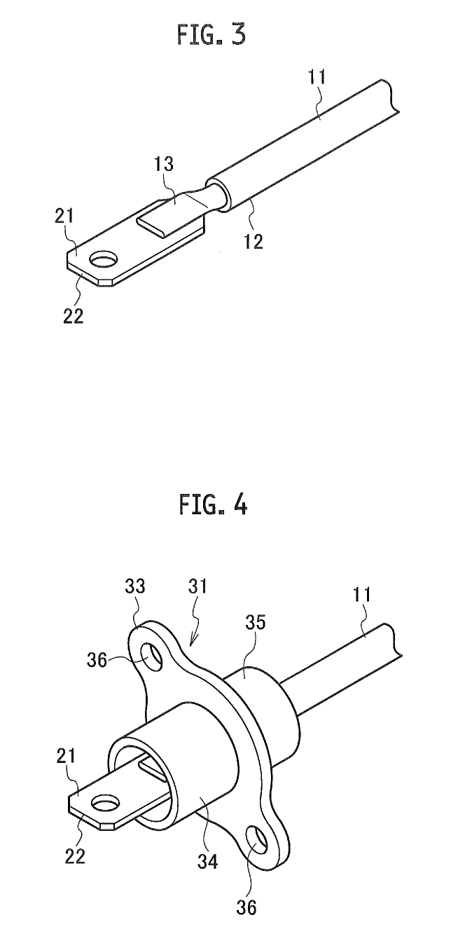

The electric wire 11 used is a shield electric wire. As illustrated in FIG. 3, an end portion 12 of the electric wire 11 is connected with the terminal fitting 21. The electric wire 11 has a configuration in which a conductor is covered with an inner insulating layer, the inner insulating layer is covered with a shield layer formed of a braided wire, and the shield layer is covered with an outer insulating layer. The shield layer is folded back over the outer insulating layer, the conductor is exposed at the end portion 12, and an exposed portion 13 of the conductor is connected to the terminal fitting 21.

The terminal fitting 21 is a component for a conductive function. A tip portion 22 of the terminal fitting 21 is exposed to the outside of the connector 1 and connected to a terminal (not illustrated) of a mating connector 3 of an apparatus or the like.

The shield shell 31 is a component used for electromagnetic shielding and is entirely formed of metal. The shield shell 31 includes a wire insertion cylindrical body 32 formed into a cylindrical shape, and a fixing flange portion 33 spreading out in a direction orthogonal to the longitudinal direction of the wire insertion cylindrical body 32. The end portion 12 of the electric wire 11 and the terminal fitting 21 connected to the end portion 12 of the electric wire 11 are inserted into the wire insertion cylindrical body 32. The wire insertion cylindrical body 32 includes a front end cylindrical portion 34 and a rear end cylindrical portion 35 communicating with each other, the front end cylindrical portion 34 housing the connected portion of the end portion 12 of the electric wire 11 and the terminal fitting 21 connected thereto, the rear end cylindrical portion 35 leading the electric wire 11 out thereof. The end portion 12 of the electric wire 11 and the terminal fitting 21 are inserted into the wire insertion cylindrical body 32 so as to be shielded from electromagnetic waves.

The fixing flange portion 33 is used for fixing the connector 1 to the mating connector 3 of an apparatus. The fixing flange portion 33 is provided with fixing holes 36 into which fixing screws are inserted. The mating connector 3 is provided with an attachment hole 5. The connector 1 is fixed to the mating connector 3 in a manner such that the front end cylindrical portion 34 is inserted into the attachment hole 5.

The integrated housing 41 used for integrally fixing the shield shell 31, the end portion 12 of the electric wire 11, and the terminal fitting 21 is integrated with the shield shell 31, the end portion 12 of the electric wire 11, and the terminal fitting 21. The integrated housing 41 includes a front end cylindrical housing portion 42, a rear end cylindrical housing portion 43, and a wire leading-side housing portion 44, and is entirely molded from an insulating resin material. The integrated housing 41 molded from the insulating resin material functions to insulate the respective components.

The front end cylindrical housing portion 42 is integrated with the front end cylindrical portion 34 of the shield shell 31. The front end cylindrical housing portion 42 integrated with the front end cylindrical portion 34 functions to protect the connected portion of the terminal fitting 21 and the electric wire 11 against water. The rear end cylindrical housing portion 43 is integrated with the rear end cylindrical portion 35 of the shield shell 31. The rear end cylindrical housing portion 43 integrated with the rear end cylindrical portion 35 functions to protect the electric wire 11 against water. The wire leading-side housing portion 44 is integrated with the electric wire 11 led out of the rear end cylindrical portion 35 of the shield shell 31. The wire leading-side housing portion 44 extends from the rear end cylindrical housing portion 43 toward the rear of the electric wire 11.

The front end cylindrical housing portion 42 is not only provided in and integrated with the front end cylindrical portion 34 but also molded over an outer wall of the front end cylindrical portion 34. The front end cylindrical housing portion 42 thus further includes a covering portion 45 covering the outer wall of the front end cylindrical portion 34 of the shield shell 31. The covering portion 45 is provided with a plurality of (two in FIGS. 1 and 2) seal portions 46 projecting into a ring. The seal portions 46 tightly come into contact with an inner wall of the attachment hole 5 of the mating connector 3. The seal portions 46 in tight contact with the attachment hole 5 of the mating connector 3 can protect the attached portion of the connector 1 in contact with the mating connector 3 against water. Since the covering portion 45 covers the front end cylindrical portion 34 of the shield shell 31, the integrated housing 41 also has a reinforcing function to have resistance to external force applied thereto when, for example, the connector 1 is assembled.

In addition, the front end cylindrical housing portion 42 of the integrated housing 41 has a function to hold the end portion 12 of the electric wire 11 and the terminal fitting 21 housed in the front end cylindrical portion 34 of the shield shell 31. The rear end cylindrical portion 43 has a function to hold the electric wire 11 inserted into the rear end cylindrical portion 35 of the shield shell 31.

In order to have the insulating function, the waterproof function, the holding function, and the reinforcing function, the integrated housing 41 is formed of a resin material having adhesion to the components excluding the shield shell 31 and having greater hardness than rubber and lower hardness than resin materials generally used for housings (for example, PBT), and is particularly preferably formed of an elastomer resin material. Such an elastomer resin material preferably used may be obtained in a manner such that styrene elastomer, olefin elastomer, polyvinyl chloride elastomer, polyester elastomer, polyurethane elastomer, or nylon elastomer is used as a base, and an adhesive with a hydroxyl group (OH group) having a hydrogen bond to metal is mixed to the base elastomer.

Next, the process of assembling the connector 1 according to the first embodiment is explained with reference to FIGS. 3 to 5. FIG. 3 illustrates a state where the terminal fitting 21 is connected to the end portion 12 of the electric wire 11. The electric wire 11 and the terminal fitting 21 connected thereto are inserted into the shield shell 31. FIG. 4 illustrates the inserted state in which the end portion 12 of the electric wire 11 and the terminal fitting 21 are inserted into the wire insertion cylindrical body 32 of the shield shell 31 in a manner such that the tip portion of the terminal fitting 21 is exposed to the outside of the front end cylindrical portion 34 of the shield shell 31.

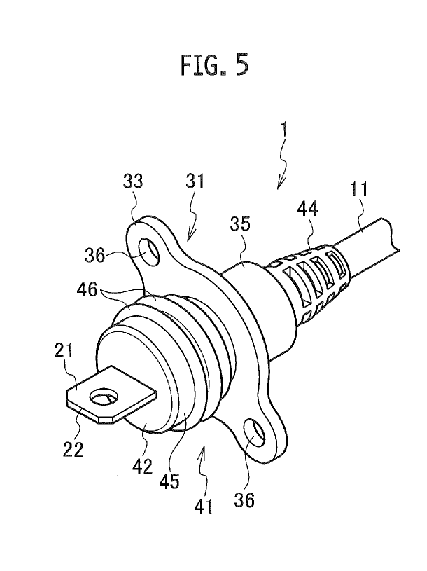

The elastomer resin material is poured into a metal die and subjected to molding in a state where the components attached together as illustrated in FIG. 4 are inserted in the metal die. Accordingly, the integrated housing 41 is formed in which the front end cylindrical housing portion 42, the rear end cylindrical housing portion 43, the wire leading-side housing portion 44, and the covering portion 45 are molded together. In the state illustrated in FIG. 5, the front end portion of the terminal fitting 21 is exposed to the outside of the front end cylindrical housing portion 42 of the integrated housing 41 so as to be connected to a terminal of the mating connector 3.

Here, reference numeral 7 illustrated in FIGS. 1, 2, 6, and 7 is a crimp ring for crimping the shield shell 31 covered with an end portion of a shield member (such as braid) so as to be connected and fixed together.

According to the first embodiment, the integrated housing 41 is molded on the end portion 12 of the electric wire 11 and the terminal fitting 21 so as to integrally fix the end portion 12 of the electric wire 11 and the terminal fitting 21. The integrated housing 41 thus has the waterproof function to protect the electric wire 11 and the terminal fitting 21 against water, in addition to the function to insulate the respective components and the component-holding function. Since the integrated housing 41 has the function to insulate the respective components, the component-holding function, and the waterproof function, the number of the components required for the connector 1 to ensure the necessary functions can be reduced. The decrease in the number of the components can simplify the process of assembling the connector 1 to decrease the assembling steps. The decrease in the number of the components can further save the space for the respective components so as to reduce the size of the connector 1.

The integrated housing 41 is also integrated with the shield shell 31 together with the end portion 12 of the electric wire 11 and the terminal fitting 21 so as to integrally fix the end portion 12 of the electric wire 11, the terminal fitting 21 and also the shield shell 31. Thus, the shield shell 31 functions as a reinforcing member of the integrated housing 41. Accordingly, the integrated housing 41 can be formed of a material having lower rigidity than materials generally used for housings, which expands the possibility of materials to be selected. Since the integrated housing 41 in the present embodiment is formed of a material having lower rigidity than materials generally used for housings, the seal portions 46 can be formed directly on the integrated housing 41, which also reduces the number of the components.

### Second Embodiment

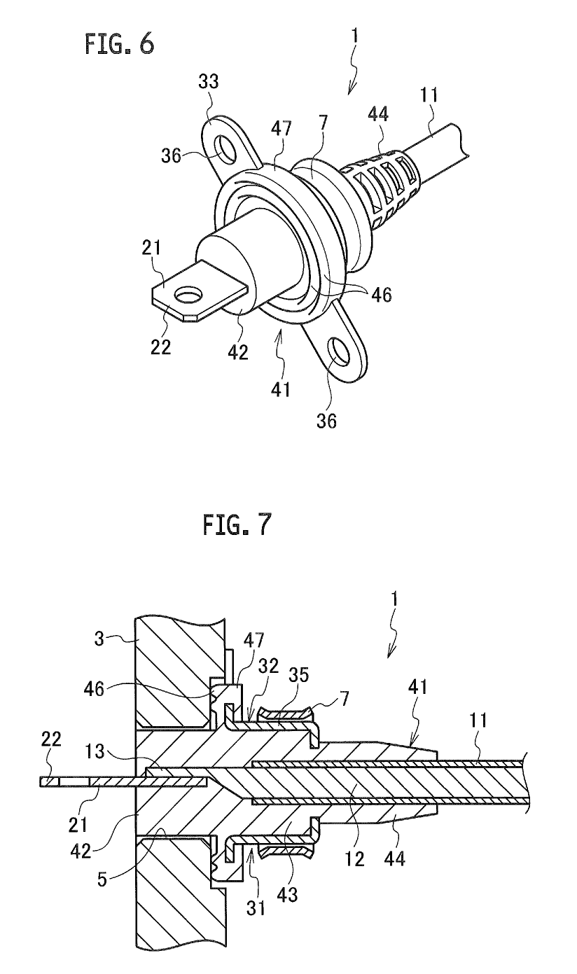

FIGS. 6 and 7 illustrate a connector 1 according to a second embodiment.

The connector 1 according to the second embodiment includes the electric wire 11, the terminal fitting 21, the shield shell 31, and the integrated housing 41, as in the case of the first embodiment. However, the configurations of the shield shell 31 and the integrated housing 41 partly differ from those of the first embodiment.

In the second embodiment, the shield shell 31 includes the wire insertion cylindrical body 32 and the fixing flange portion 33; however, the wire insertion cylindrical body 32 only includes the rear end cylindrical portion 35.

In the second embodiment, the integrated housing 41 further includes a flange-covering portion 47 covering the fixing flange portion 33 excluding the regions around the fixing holes 36, the flange-covering portion 47 being integrated with the front end cylindrical housing portion 42, the rear end cylindrical housing portion 43, and the wire leading-side housing portion 44. The flange-covering portion 47 is provided with the ring-shaped seal portions 46 projecting on a front wall of the flange-covering portion 47. The seal portions 46 tightly comes into contact with a side wall of the mating connector 3 so as to protect the attached portion in contact with the mating connector 3 against water.

In the second embodiment, the integrated housing 41 is molded on the end portion 12 of the electric wire 11 and the terminal fitting 21 so as to integrally fix the end portion 12 of the electric wire 11 and the terminal fitting 21 therewith. Thus, the integrated housing 41 has the waterproof function to protect the electric wire 11 against water in addition to the function to insulate the respective components and the component-holding function, as in the case of the first embodiment. Accordingly, the number of the components can be reduced, which can simplify the process of assembling the connector 1 and decrease the assembling steps. The decrease in the number of the components can further save the space for the respective components so as to reduce the size of the connector 1.

The integrated housing 41 is also integrated with the shield shell 31 together with the end portion 12 of the electric wire 11 and the terminal fitting 21 so as to integrally fix the end portion 12 of the electric wire 11, the terminal fitting 21, and also the shield shell 31. Thus, the shield shell 31 functions as a reinforcing member of the integrated housing 41, as in the case of the first embodiment. Accordingly, the integrated housing 41 can be formed of a material having lower rigidity than materials generally used for housings, which expands the possibility of materials to be selected. Since the integrated housing 41 in the second embodiment is formed of a material having lower rigidity than materials generally used for housings, the seal portions 46 can be foamed directly on the integrated housing 41, which also reduces the number of the components.

### Third Embodiment

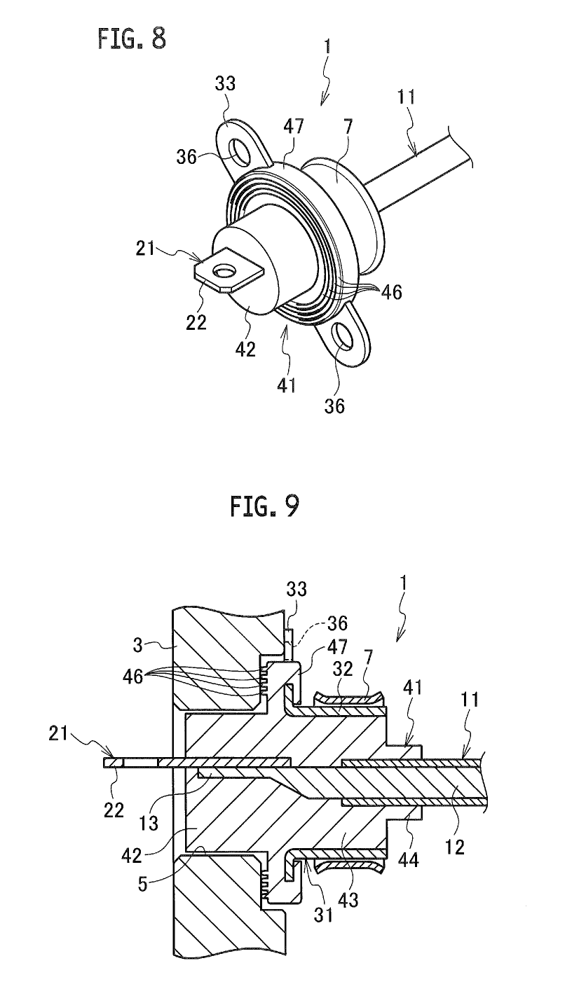

FIGS. 8 to 12 illustrate a connector 1 according to a third embodiment.

As illustrated in FIGS. 8 and 9, the connector 1 according to the third embodiment has a configuration in which the flange-covering portion 47 of the integrated housing 41 is provided with the ring-shaped seal portions 46 projecting therefrom, as in the case of the second embodiment. However, the third embodiment differs from the second embodiment in that the number of the ring-shaped seal portions 46 provided is four. The respective seal portions 46 are subjected to pressure deformation due to attachment force of the shield shell 31 toward the mating connector 3 so as to tightly come into contact with the surface of the attachment hole 5 by elastic restoring force of the pressure deformation.

The other configurations are the same as those in the second embodiment. The same elements are thus indicated by the same reference numerals, and explanations thereof are not repeated below.

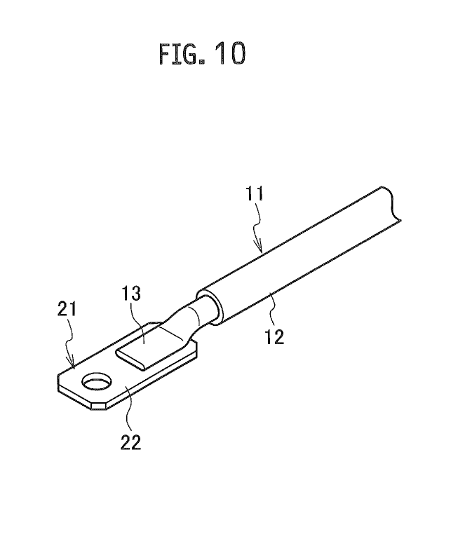

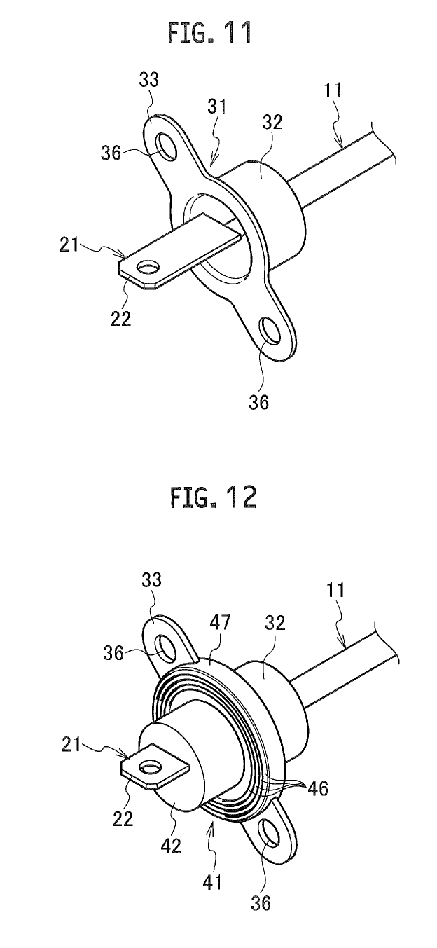

Next, the process of assembling the connector 1 according to the third embodiment is briefly explained with reference to FIGS. 10 to 12. As illustrated in FIG. 10, the end portion 12 of the electric wire 11 is connected with the terminal fitting 21. The electric wire 11 and the terminal fitting 21 are placed in a predetermined position in a metal die (not illustrated) in the state where the electric wire 11 and the terminal fitting 21 are inserted into the shield shell 31, as illustrated in FIG. 11. With the electric wire 11, the terminal fitting 21, and the shield shell 31 used as insert components, an elastomer resin material is poured into the metal die (not illustrated) so that the integrated housing 41 is molded. As a result, a molded product illustrated in FIG. 12 is produced.

Thereafter, the rear end cylindrical housing portion 43 of the shield shell 31 is covered with an end portion of a shield member (such as braid), and the crimp ring 7 is further provided thereon to crimp the shield member (such as braid) to be connected and fixed together so as to complete the assembling process (refer to FIG. 8).

In the third embodiment, the integrated housing 41 is molded on the end portion 12 of the electric wire 11 and the terminal fitting 21 so as to integrally fix the end portion 12 of the electric wire 11 and the terminal fitting 21 therewith. Accordingly, the process of assembling the connector 1 can be simplified so as to decrease the assembling steps as in the case of the first embodiment. The decrease in the number of the components can further save the space for the respective components so as to reduce the size of the connector 1.

The integrated housing 41 is also integrated with the shield shell 31 together with the end portion 12 of the electric wire 11 and the terminal fitting 21 so as to integrally fix the end portion 12 of the electric wire 11, the terminal fitting 21, and also the shield shell 31. Thus, the shield shell 31 functions as a reinforcing member of the integrated housing 41, as in the case of the first embodiment. Accordingly, the integrated housing 41 can be formed of a material having lower rigidity than materials generally used for housings, which expands the possibility of materials to be selected. Since the integrated housing 41 in the third embodiment is formed of a material having lower rigidity than materials generally used for housings, the seal portions 46 can be formed directly on the integrated housing 41, which also reduces the number of the components.

The four seal portions 46 form four layers to seal the entire gap between the inner wall of the attachment hole 5 of the mating connector 3 and the outer circumference of the integrated housing 41. Thus, as in the case of the second embodiment, high waterproof performance can be ensured due to the adhesion by the pressure deformation of the seal portions 46 and further a pressure-reducing effect of the respective seal portions 46 to gradually reduce water pressure externally applied thereto. In particular, the seal portions 46 integrated with the integrated housing 41 has hardness greater than that of a rubber (such as acrylic) material. Although the adhesion by the pressure deformation (reaction force) of the seal portion 46 per se merely shows low waterproof performance, the additional effect of reducing water pressure can be obtained when the plurality of seal portions 46 is provided so as to ensure high waterproof performance.

When the integrated housing 41 is formed of synthetic resin having greater hardness than a rubber (such as acrylic) material, performance to conform to a corrugated surface to which the integrated housing 41 is attached decreases. However, the increase in the number of the seal portions 46 can obtain preferred waterproof performance. Further, the integrated housing 41 formed of synthetic resin having greater hardness than a rubber (such as acrylic) material has high durability because of the adhesion due to the pressure deformation of the seal portions 46, namely, because of small reaction force. Accordingly, the integrated housing 41 even formed of synthetic resin having greater hardness than a rubber (such as acrylic) material can ensure a seal structure having high durability and waterproof performance when the plural seal portions 46 are formed.

### Fourth Embodiment

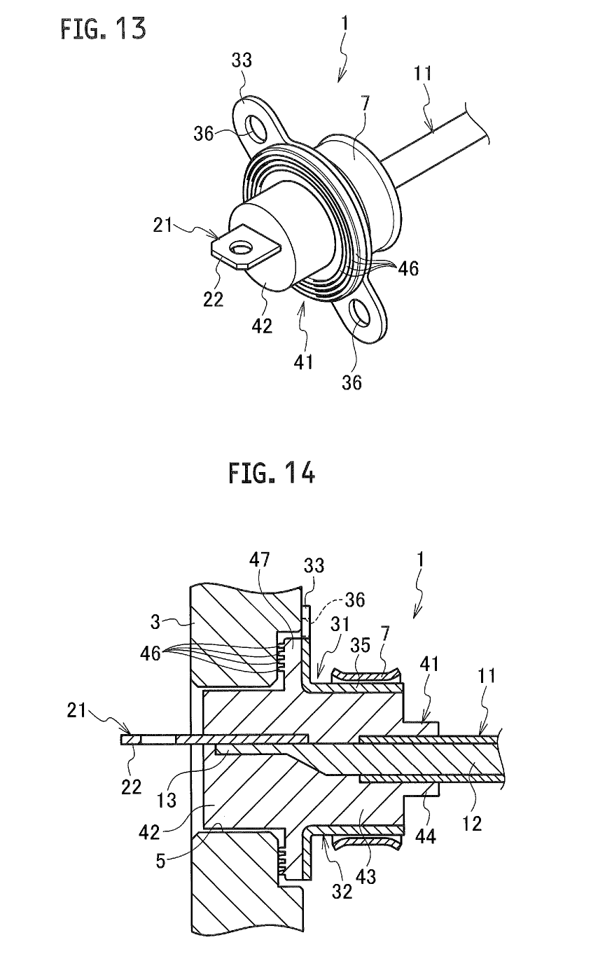

FIGS. 13 to 17 illustrate a connector 1 according to a fourth embodiment.

As illustrated in FIGS. 13 and 14, the connector 1 according to the fourth embodiment has a configuration in which the front end cylindrical housing portion 42 of the integrated housing 41 is molded on the end portion 12 of the electric wire 11 and the terminal fitting 21 and the wire leading-side housing portion 44 is molded on the electric wire 11, but differs from the connector 1 of the third embodiment in that the rear end cylindrical housing portion 43 is not integrated with the shield shell 31 but the shield shell 31 is fitted and fixed to the rear end cylindrical housing portion 43. Thus, the integrated housing 41 is molded on the end portion 12 of the electric wire 11 and the terminal fitting 21 so as to integrally fix the end portion 12 of the electric wire 11 and the terminal fitting 21 therewith, and the shield shell 31 is fitted to the integrated housing 41 so as to be fixed thereto.

The connector 1 according to the fourth embodiment also has a configuration in which the flange-covering portion 47 of the integrated housing 41 is provided with the four ring-shaped seal portions 46 projecting therefrom, as in the case of the third embodiment. However, the fourth embodiment differs from the third embodiment in that the flange-covering portion 47 only covers the front side of the fixing flange portion 33 of the shield shell 31 without covering the rear side thereof.

The other configurations are the same as those in the second embodiment. The same elements are thus indicated by the same reference numerals, and explanations thereof are not repeated below.

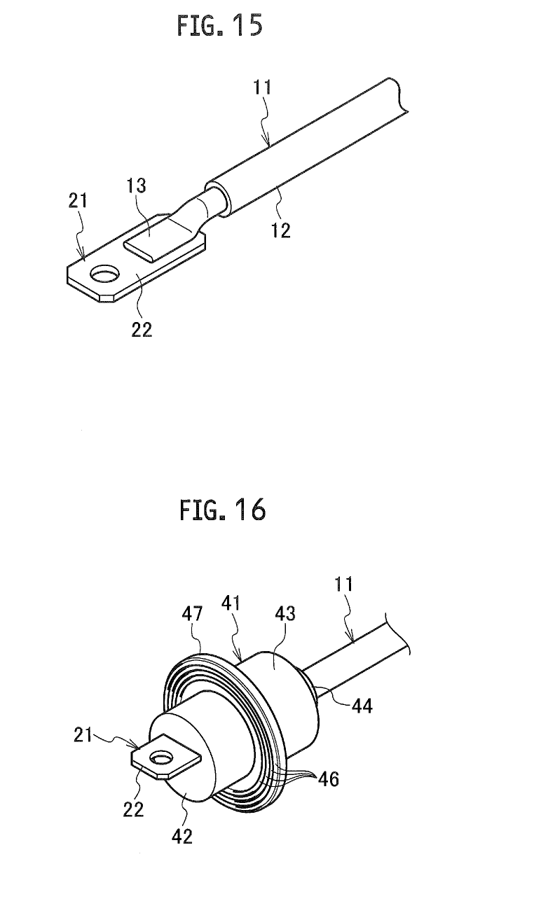

Next, the process of assembling the connector 1 according to the fourth embodiment is briefly explained with reference to FIGS. 15 to 17. As illustrated in FIG. 15, the end portion 12 of the electric wire 11 is connected with the terminal fitting 21. Subsequently, the electric wire 11 and the terminal fitting 21 used as insert components are placed in a predetermined position in a metal die (not illustrated), and an elastomer resin material is poured into the metal die (not illustrated) so that the integrated housing 41 is molded. As a result, a molded product illustrated in FIG. 16 is produced.

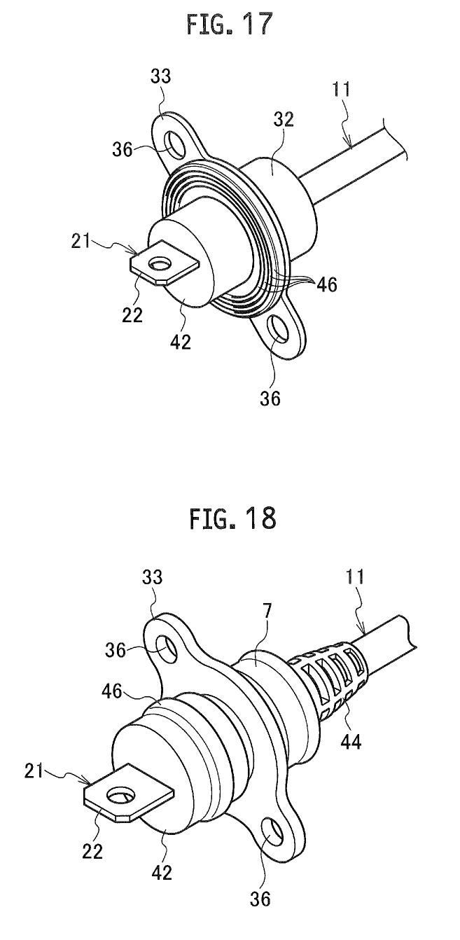

As illustrated in FIG. 17, the shield shell 31 is then fitted onto the outer circumference of the rear end cylindrical housing portion 43 of the integrated housing 41.

Thereafter, the shield shell 31 is covered with an end portion of a shield member (such as braid), and the crimp ring 7 is further provided thereon to crimp the shield member (such as braid) to be connected and fixed together so as to complete the assembling process (refer to FIG. 13).

In the fourth embodiment, the integrated housing 41 is molded on the end portion 12 of the electric wire 11 and the terminal fitting 21 so as to integrally fix the end portion 12 of the electric wire 11 and the terminal fitting 21 therewith. Accordingly, the process of assembling the connector 1 can be simplified so as to decrease the assembling steps as in the case of the first embodiment. The decrease in the number of the components can further save the space for the respective components so as to reduce the size of the connector 1.

The integrated housing 41 is molded on the end portion 12 of the electric wire 11 and the terminal fitting 21 so as to integrally fix the end portion 12 of the electric wire 11 and the terminal fitting 21 therewith. The shield shell 31 is then fitted to the integrated housing 41 so that the shield shell 31 is fixed to the integrated housing 41. Thus, the shield shell 31 functions as a reinforcing member of the integrated housing 41, as in the case of the first embodiment. Accordingly, the integrated housing 41 can be formed of a material having lower rigidity than materials generally used for housings, which expands the possibility of materials to be selected. Since the integrated housing 41 in the fourth embodiment is formed of a material having lower rigidity than materials generally used for housings, the seal portions 46 can be formed directly on the integrated housing 41, which also reduces the number of the components.

### Fifth Embodiment

FIGS. 18 to 22 illustrate a connector 1 according to a fifth embodiment.

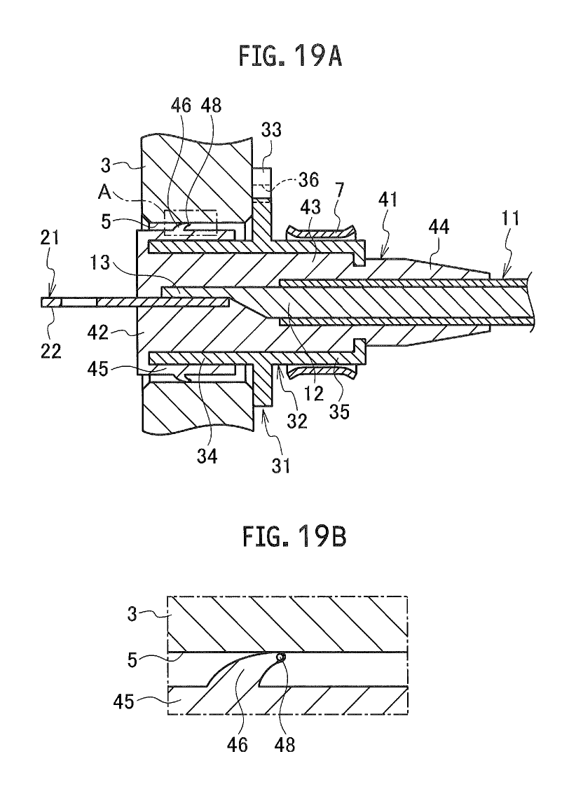

As illustrated in FIGS. 18 and 19A, the connector 1 according to the fifth embodiment differs from the connector 1 of the first embodiment only in the configuration of the seal portion 46. The other configurations are the same as those in the first embodiment. The same elements are thus indicated by the same reference numerals in the drawings, and explanations thereof are not repeated below.

As illustrated in FIG. 19B, the single ring-shaped seal portion 46 is formed along the outer circumference of the covering portion 45 of the integrated housing 41. The seal portion 46 is tapered toward the tip thereof The ring-shaped seal portion 46 is provided with a ring-shaped permanent magnet inside thereof

A circumferential edge of the attachment hole 5 of the mating connector 3 to which the seal portion 46 tightly adheres is at least formed of a ferromagnetic material (such as an iron material).

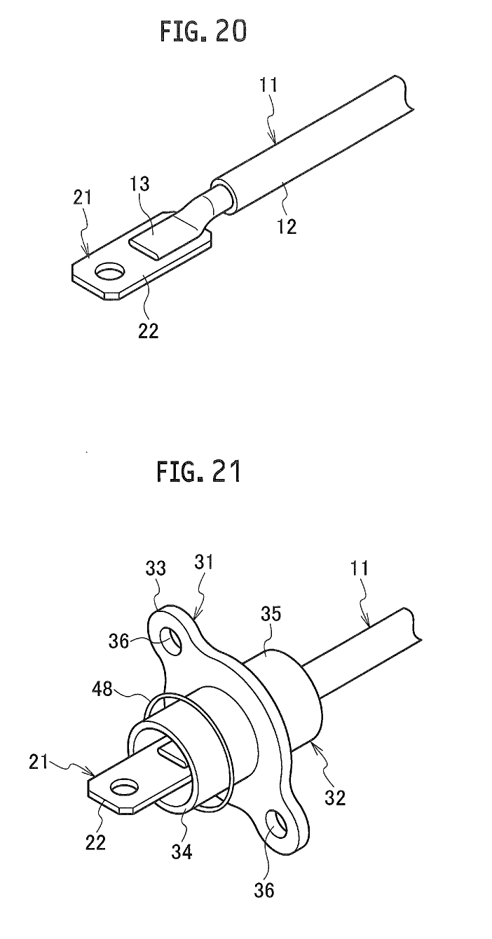

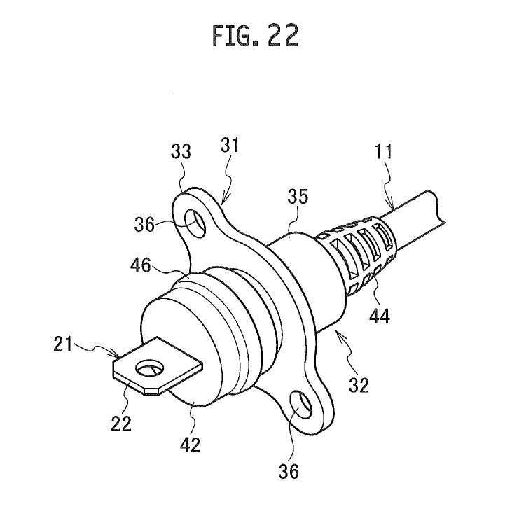

Next, the process of assembling the connector 1 according to the fifth embodiment is briefly explained with reference to FIGS. 20 to 22. As illustrated in FIG. 20, the end portion 12 of the electric wire 11 is connected with the terminal fitting 21. The electric wire 11, the terminal fitting 21, the shield shell 31, and the ring-shaped permanent magnet 48 illustrated in FIG. 21 are placed in a predetermined position in a metal die (not illustrated). With the electric wire 11, the terminal fitting 21, the shield shell 31, and the permanent magnet 48 used as insert components, an elastomer resin material is poured into the metal die (not illustrated) so that the integrated housing 41 is molded. As a result, a molded product illustrated in FIG. 22 is produced.

Thereafter, the shield shell 31 is covered with an end portion of a shield member (such as braid), and the crimp ring 7 is further provided thereon to crimp the shield member (such as braid) to be connected and fixed together so as to complete the assembling process (refer to FIG. 18).

In the fifth embodiment, the integrated housing 41 is molded on the end portion 12 of the electric wire 11 and the terminal fitting 21 so as to integrally fix the end portion 12 of the electric wire 11 and the terminal fitting 21 therewith. Thus, the integrated housing 41 has the waterproof function to protect the electric wire 11 and the terminal fitting 21 against water in addition to the function to insulate the respective components and the component-holding function, as in the case of the first embodiment. Accordingly, the number of the components can be reduced, which can simplify the process of assembling the connector 1 and decrease the assembling steps. The decrease in the number of the components can further save the space for the respective components so as to reduce the size of the connector 1.

The integrated housing 41 is also integrated with the shield shell 31 together with the end portion 12 of the electric wire 11 and the terminal fitting 21 so as to integrally fix the end portion 12 of the electric wire 11, the terminal fitting 21, and also the shield shell 31. Thus, the shield shell 31 functions as a reinforcing member of the integrated housing 41, as in the case of the first embodiment. Accordingly, the integrated housing 41 can be formed of a material having lower rigidity than materials generally used for housings, which expands the possibility of materials to be selected. Since the integrated housing 41 in the fifth embodiment is fanned of a material having lower rigidity than materials generally used for housings, the seal portion 46 can be formed directly on the integrated housing 41, which also reduces the number of the components.

The seal portion 46 is provided with the permanent magnet 48. The adhesion due to the pressure deformation of the resin portion in the seal portion 46 and further magnetic adhesion of the permanent magnet 48 can ensure high waterproof performance. Further, the integrated housing 41 even formed of a synthetic resin material having low durability can maintain the adhesive durability of the seal portion 46 due to the permanent magnet 48 having the magnetic adhesion. This expands the possibility of materials to be selected. In addition, the tapered shape of the seal portion 46 contributes to elastic deformation, conformity to the corrugated surface to be attached and high adhesion so as to improve the waterproof performance.

Although only one seal portion 46 is used in the fifth embodiment, a plurality of seal portions 46 may be provided.

### Sixth Embodiment

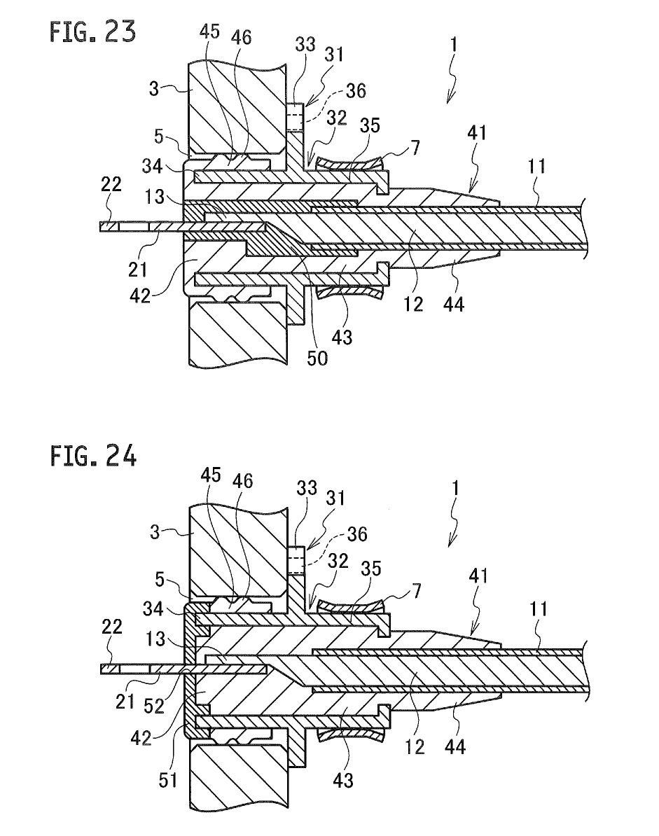

FIG. 23 illustrates a connector 1 according to a sixth embodiment.

The connector 1 according to the sixth embodiment includes the electric wire 11, the terminal fitting 21, the shield shell 31, and the integrated housing 41, as in the case of the first embodiment. However, the configuration of the integrated housing 41 partly differs from that of the first embodiment.

In the sixth embodiment, the integrated housing 41 is provided therein with an inner housing 50 molded from a resin material different from that used for the integrated housing 41. The resin material used for the inner housing 50 has greater hardness than that used for the integrated housing 41. The integrated housing 41 is thus formed of a resin material having lower hardness than the resin material of the inner housing 50.

The inner housing 50 is integrated with an end portion of the inner insulating layer of the electric wire 11, the exposed conductor of the electric wire 11 and most of the terminal fitting 21 on the electric wire 11 side so as to insulate the respective components and fix the end portion 12 of the electric wire 11 and the terminal fitting 21 therewith.

The integrated housing 41 is integrated with the inner housing 50, the shield shell 31 and, part of the electric wire 11.

According to the sixth embodiment, an additional metal die for molding the inner housing 50 is only required to assemble the connector 1 so as to easily modify the connector 1 of the first embodiment.

According to the sixth embodiment, the inner housing 50 has the function to insulate the respective components and also the function to reinforce the electric wire 11 and the terminal fitting 21. This expands the possibility of resin materials selected for the integrated housing 41 so as to reduce the material costs. Since the integrated housing 41 is formed of a resin material having lower hardness, the seal portions 46 can tightly come into contact with the inner wall of the attachment hole 5 of the mating connector 3 more reliably so as to further improve the waterproof performance to protect the attached portion of the connector 1 in contact with the mating connector 3 against water.

The other configurations and effects obtained are the same as those in the first embodiment, and explanations thereof are thus not repeated below.

### Seventh Embodiment

FIG. 24 illustrates a connector 1 according to a seventh embodiment.

The connector 1 according to the seventh embodiment includes the electric wire 11, the terminal fitting 21, the shield shell 31, and the integrated housing 41, as in the case of the first embodiment. However, the configuration of the integrated housing 41 partly differs from that of the first embodiment.

In the seventh embodiment, a front holder 51 is additionally provided as a separate member on the front surface of the integrated housing 41. The front holder 51 includes an insertion inlet 52 into which the end portion of the terminal fitting 21 is inserted. The front holder 51 is locked with or press fitted into the edge of the front end cylindrical portion 34 of the shield shell 31 so as to be fixed thereto. Accordingly, the front holder 51 can firmly hold the terminal fitting 21.

The front holder 51 is formed of an insulating resin material such as polybutylene terephthalate (PBT) or syndiotactic polystyrene (SPS) which is a hard material generally used for connector housings.

According to the seventh embodiment, the part corresponding to the front holder 51 is only required to be removed from the metal die used in the first embodiment when the integrated housing 41 is molded to assemble the connector 1 so as to easily modify the connector 1 of the first embodiment.

The other configurations and effects obtained are the same as those in the first embodiment, and explanations thereof are thus not repeated below.

### Eighth Embodiment

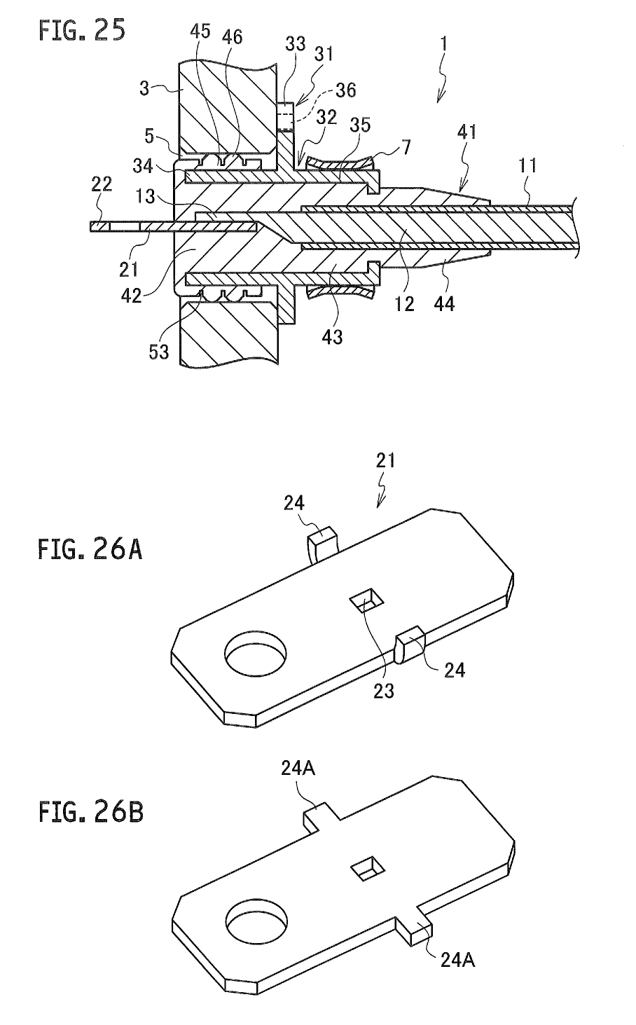

FIG. 25 illustrates a connector 1 according to an eighth embodiment.

The connector 1 according to the eighth embodiment includes the electric wire 11, the terminal fitting 21, the shield shell 31, and the integrated housing 41, as in the case of the first embodiment. However, the configuration adjacent to the seal portions 46 of the integrated housing 41 partly differs from that of the first embodiment.

In the connector 1 according to the eighth embodiment, grooves 53 are additionally provided in the connector 1 of the first embodiment along the circumference of the housing in front of and behind the respective seal portions 46 in the insertion direction of the connector 1. According to the eighth embodiment, the three grooves 53 are provided in front of and behind each of the two seal portions 46. The grooves 53 allow the seal portions 46 to be deformed more easily so as to decrease insertion force applied to the connector 1 when being attached to the mating connector 3.

The other configurations and effects obtained are the same as those in the first embodiment, and explanations thereof are thus not repeated below.

### Ninth Embodiment

FIG. 26A illustrates a terminal fitting 21 used in a ninth embodiment. The ninth embodiment differs from the first to eighth embodiments in part of the configuration of the terminal fitting 21.

In the ninth embodiment, the terminal fitting 21 includes a hole 23 located substantially in the middle of the terminal fitting 21 and extending portions 24 provided on both sides of the terminal fitting 21.

The hole 23 is formed in such a manner as to penetrate the terminal fitting 21 but is not limited thereto and may be formed into a groove not penetrating the terminal fitting 21. Although FIG. 26A illustrates the hole 23 formed into a square shape, the hole 23 is not limited thereto and may be formed into any shape such as a circle.

The extending portions 24 project on both sides of the terminal fitting 21 toward one surface of the terminal fitting 21 but is not limited thereto. The extending portions 24 may project toward both surfaces of the terminal fitting 21 or may be provided only on one side of the terminal fitting 21.

The hole 23 and the extending portions 24 are formed in the terminal fitting 21 at positions on which the integrated housing 41 is molded. When the integrated housing 41 is molded on the terminal fitting 21, the resin material flows to the hole 23 and the extending portions 24. As a result, the integrated housing 41 can hold the terminal fitting 21 more firmly.

As illustrated in FIG. 26B as a modified example of the ninth embodiment, extending portions 24A may be provided in such a manner as to project on both sides of the terminal fitting 21 in the width direction of the terminal fitting 21. It should be noted that the extending portions 24A illustrated in FIG. 26B increase the size of the terminal fitting 21 in the width direction.

The other configurations and effects obtained are the same as those in the first to eighth embodiments, and explanations thereof are thus not repeated below.

What is claimed is:

1. A connector, comprising:
an electric wire;
a terminal fitting connected to an end portion of the electric wire; and
an integrated housing molded on the end portion of the electric wire and the terminal fitting in a state where a tip portion of the terminal fitting is exposed to an outside of the integrated housing so as to integrally fix the end portion of the electric wire and the terminal fitting.

2. The connector according to claim 1, further comprising a shield shell into which the terminal fitting and the end portion of the electric wire are inserted,
wherein the integrated housing is integrated with the shield shell together with the end portion of the electric wire and the terminal fitting so as to integrally fix the end portion of the electric wire, the terminal fitting, and the shield shell.

3. The connector according to claim 2, wherein:
the shield shell comprises a wire insertion cylindrical body into which the end portion of the electric wire and the terminal fitting connected to the end portion of the electric wire are inserted, and a fixing flange portion used for fixing the connector to a mating connector;
the wire insertion cylindrical body comprises a front end cylindrical portion in which the end portion of the electric wire is housed, and a rear end cylindrical portion of which the electric wire is lead out; and
the integrated housing comprises a front end cylindrical housing portion integrated with the front end cylindrical portion, a rear end cylindrical housing portion integrated with the rear end cylindrical portion, and a wire leading-side housing portion integrated with the electric wire led out of the rear end cylindrical portion.

4. The connector according to claim 1, wherein the integrated housing is provided with a seal portion that tightly comes into contact with a mating connector.

5. The connector according to claim 4, wherein a plurality of seal portions, each corresponding to the seal portion, is formed.

6. The connector according to claim 4, wherein each seal portion is provided with a permanent magnet.
